(19) United States
(12) Patent Application Publication
(10) Pub. No.: US 2015/0243213 A1
(43) Pub. Date: Aug. 27, 2015

(54) ORGANIC LIGHT EMITTING DISPLAY DEVICE AND DRIVING METHOD THEREOF

(71) Applicant: SAMSUNG DISPLAY CO., LTD., Yongin-City (KR)

(72) Inventors: Do-Hyung Ryu, Yongin-City (KR); Jae-Hoon Lee, Yongin-City (KR); Hae-Goo Jung, Yongin-City (KR)

(21) Appl. No.: 14/574,211

(22) Filed: Dec. 17, 2014

(30) Foreign Application Priority Data
Feb. 26, 2014 (KR) 10-2014-0022288

(51) Int. Cl. G09G 3/32

(52) U.S. Cl. CPC G09G 3/3216; G09G 2330/021

(57) ABSTRACT

Provided is an organic light emitting display device including: a data voltage controller configured to calculate power consumption according to input image data, and to output a voltage control signal corresponding to the calculated power consumption; a data voltage generator configured to regulate and output at least one of first and second voltages corresponding to the voltage control signal; a data driver configured to generate a data signal according to the input image data and at least one of the first voltage or the second voltage, and to output the data signal; and a plurality of pixels configured to selectively emit light corresponding to the data signal.

### CROSS-REFERENCE TO RELATED APPLICATION

This application claims priority to and the benefit of Korean Patent Application No. 10-2014-0022288, filed on Feb. 26, 2014, in the Korean Intellectual Property Office, the entire contents of which are incorporated herein by reference in their entirety.

### BACKGROUND

1. Field

Aspects of embodiments of the present invention relate to an organic light emitting display device and a driving method thereof.

2. Description of the Related Art

An organic light emitting display device displays images using organic light emitting diodes (OLEDs) that emit light through recombination of electrons and holes. The organic light emitting display device can be driven by an analog driving method or a digital driving method.

Among these driving methods, the digital driving method is a method of expressing gray scale levels by controlling the emission time of each pixel. In the digital driving method, the lowering of image quality due to a luminance difference generated in the analog driving method does not occur, so that it is possible to implement a simple pixel circuit and to reduce power consumption. Thus, the digital driving method has recently been widely applied for driving the organic light emitting display device.

### SUMMARY

Aspects of example embodiments of the present invention relate to an organic light emitting display device and a driving method thereof, which can reduce charging/discharging power consumption.

According to an example embodiment of the present invention, there is provided an organic light emitting display device including: a data voltage controller configured to calculate power consumption according to input image data, and to output a voltage control signal corresponding to the calculated power consumption; a data voltage generator configured to regulate and output at least one of first and second voltages corresponding to the voltage control signal; a data driver configured to generate a data signal according to the input image data and at least one of the first voltage or the second voltage, and to output the data signal; and a plurality of pixels configured to selectively emit light corresponding to the data signal.

The data voltage controller may be configured to calculate charging/discharging power consumption corresponding to the input image data, and to output the voltage control signal for controlling a voltage difference between the first and second voltages to be regulated corresponding to the charging/discharging power consumption.

The data voltage controller may be further configured to output the voltage control signal for decreasing the voltage difference between the first and second voltages as the charging/discharging power consumption increases.

The data voltage controller may be further configured to output the voltage control signal for constantly maintaining the voltage difference between the first and second voltages when the charging/discharging power consumption has at least a predetermined value.

The data voltage controller may include: a data storage unit configured to store the input image data during a period; a power consumption calculation unit configured to calculate the power consumption corresponding to the input image data; and a control signal generation unit configured to generate and output the voltage control signal corresponding to the power consumption.

The input image data may have a digital value.

The power consumption calculation unit may include: a transition calculation unit configured to calculate a number of times data lines are charged/discharged based on the input image data, and to output the calculated number of times as a transition counting value; and a charging/discharging power consumption calculation unit configured to calculate charging/discharging power consumption based on the transition counting value.

The transition calculation unit may be further configured to calculate the transition counting value for each frame.

The power consumption calculation unit may include: a loading value calculation unit configured to calculate an image loading value corresponding to the input image data; and a power consumption prediction unit configured to predict power consumption corresponding to the image loading value.

The data voltage generator may be further configured to generate the first and second voltages, and to output the generated first and second voltages to the data driver. The data voltage generator may include a variable circuit configured to vary and output at least one of the first and second voltages corresponding to the voltage control signal.

The organic light emitting display device may further include a temperature sensor configured to sense a temperature of a panel on which the pixels are located, and to output a temperature signal corresponding to the sensed temperature.

The control signal generation unit may be further configured to generate the voltage control signal according to both the power consumption and the temperature signal.

According to another example embodiment of the present invention, there is provided a method of driving an organic light emitting display, the method including: calculating power consumption corresponding to input image data; generating a voltage control signal corresponding to the power consumption; regulating and outputting at least one of first and second voltages corresponding to the voltage control signal; generating a data signal according to the input image data and at least one of the first voltage or the second voltage; and supplying the data signal to pixels to selectively emit light corresponding to the data signal.

The calculating of the power consumption may include calculating charging/discharging power consumption corresponding to the input image data.

The calculating of the charging/discharging power consumption may include: calculating a number of times data lines are charged/discharged based on the input image data supplied in a form of a digital value, and outputting the calculated number of times as a transition counting value; and calculating the charging/discharging power consumption based on the transition counting value.

The generating of the voltage control signal may include generating the voltage control signal for controlling a voltage difference between the first and second voltages so that the voltage difference is decreased as the power consumption increases.

The generating of the voltage control signal may include generating the voltage control signal for constantly maintaining the voltage difference between the first and second voltages when the power consumption has at least a predetermined value.

The calculating of the power consumption may include: calculating an image loading value corresponding to the input image data; and predicting power consumption corresponding to the image loading value.

The method may further include sensing a temperature of a panel on which the pixels are located, and outputting a temperature signal corresponding to the sensed temperature.

The voltage control signal may be generated according to both the power consumption and the temperature signal.

### BRIEF DESCRIPTION OF THE DRAWINGS

Example embodiments will now be described more fully hereinafter with reference to the accompanying drawings; however, aspects of the present invention may be embodied in various different forms and should not be construed as limited to the embodiments set forth herein. Rather, these example embodiments are provided so that this disclosure will be thorough and complete, and will fully convey the spirit and scope of the present invention to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a circuit diagram illustrating an example of a pixel to be employed in an organic light emitting display device.

FIG. 2 is a diagram illustrating one frame of an organic light emitting display device driven by a digital driving method.

FIG. 3 is a block diagram illustrating an organic light emitting display device according to an example embodiment of the present invention.

FIG. 4 is a block diagram illustrating a data voltage controller according to an example embodiment of the present invention.

FIG. 5 is a diagram illustrating a method of calculating a transition counting value during one subframe period through a transition calculation unit shown in FIG. 4, according to an example embodiment of the present invention.

FIG. 6 is a graph illustrating a voltage range of a data signal controlled corresponding to a transition counting value, according to an example embodiment of the present invention.

FIGS. 7A and 7B are waveform diagrams illustrating a method of controlling a voltage range of a data signal, corresponding to a transition counting value, according to an example embodiment of the present invention.

FIG. 8 is a block diagram illustrating a data voltage controller according to another example embodiment of the present invention.

FIG. 9 is a block diagram illustrating a data voltage controller according to still another example embodiment of the present invention.

### DETAILED DESCRIPTION

Hereinafter, aspects of example embodiments according to the present invention will be described with reference to the accompanying drawings. Here, when a first element is described as being coupled to a second element, the first element may be not only directly coupled to the second element but may also be indirectly coupled to the second element via a third element. Further, some of the elements that are not necessary for a complete understanding of the invention may have been omitted for clarity. Also, like reference numerals refer to like elements throughout.

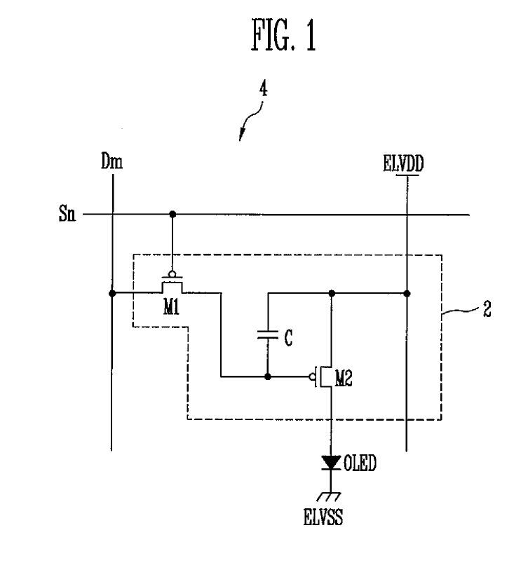

FIG. 1 is a circuit diagram illustrating an example of a pixel to be employed in an organic light emitting display. FIG. 2 is a diagram illustrating one frame of an organic light emitting display device driven by a digital driving method.

First, referring to FIG. 1, the pixel 4 includes an organic light emitting diode OLED, and a pixel circuit 2 configured to control the organic light emitting diode OLED.

An anode electrode of the organic light emitting diode OLED is coupled (e.g., connected) to the pixel circuit 2, and a cathode electrode of the organic light emitting diode OLED is coupled to a second pixel power source ELVSS. The organic light emitting diode OLED emits light or does not emit light, corresponding to current supplied from the pixel circuit 2.

The pixel circuit 2 is coupled to a scan line Sn and a data line Dm, and receives scan and data signals respectively from the scan line Sn and the data line Dm. The pixel circuit 2 controls the supply of driving current to the organic light emitting diode OLED, corresponding to (e.g., according to) the data signal supplied from the data line Dm when the scan signal is supplied from the scan line Sn.

For example, the pixel circuit 2 includes a second transistor M2 coupled between a first pixel power source ELVDD and the organic light emitting diode OLED, a first transistor M1 coupled to the second transistor M2, the data line Dm, and the scan line Sn, and a storage capacitor C coupled between a gate electrode and a first electrode of the second transistor M2.

A gate electrode of the first transistor M1 is coupled to the scan line Sn, and a first electrode of the first transistor M1 is couple to the data line Dm. A second electrode of the first transistor M1 is coupled to a first electrode of the storage capacitor C. The first transistor M1 is turned on when the scan signal is supplied from the scan line Sn, to supply the data signal supplied from the data line Dm to the storage capacitor C. When the data signal is supplied to the storage capacitor C, the storage capacitor C charges a voltage corresponding to the data signal.

The gate electrode of the second transistor M2 is coupled to the first electrode of the storage capacitor C, and the first electrode of the second transistor M2 is coupled to a second electrode of the storage capacitor C and the first pixel power source ELVDD. A second electrode of the second transistor M2 is coupled to the anode electrode of the organic light emitting diode OLED. The second transistor M2 operates as a switch for controlling the luminance of the organic light emitting diode OLED or controlling the organic light emitting diode OLED to selectively emit light (e.g., to emit light or not to emit light) during an emission period (e.g., a predetermined emission period). The second transistor M2 controls driving current flowing from the first pixel power source ELVDD to the second pixel power source ELVSS via the organic light emitting diode OLED, corresponding to the voltage stored in the storage capacitor C.

The pixels of the organic light emitting display device displays an image by repeating the process described above.

In an organic light emitting display device driven by an analog driving method, a data voltage corresponding to the gray scale level (e.g., gray level) of corresponding data is supplied as a data signal through the data line Dm of the pixel 4. Current corresponding to the data signal flows through the organic light emitting diode OLED through the second transistor M2, thereby displaying a gray scale level from the pixel 4. However, in the analog driving method, the pixel 4 has difficulty in expressing an exact or substantially exact gray scale level due to various difference factors, such as a difference in threshold voltage of the second transistor M2.

On the other hand, in the organic light emitting display device driven by the digital driving method in which the second transistor M2 operates as a switch, one frame 1F is divided into a plurality of subframes SF (e.g., SF1-SF8) as shown in FIG. 2.

Each subframe SF is configured to include a selection period and an emission period. When scan lines S (e.g., Sn) are selected by a driving order (e.g., a predetermined driving order) during the selection period so that the first transistor M1 is turned on, pixels coupled to the selected scan lines S receive first or second data as the data signal through the coupled data lines D (e.g., Dm). Here, the first and second data are different data from each other. For example, when the first data is set as data for allowing the pixel not to emit light, e.g., data of “0”, the second data is set as data for allowing the pixel to emit light, e.g., data of “1”. Here, the data of “0” and “1” may be supplied as high and low voltages opposite to each other.

That is, according to the digital driving method, the pixels 4 are selected to selectively emit light (e.g., to emit light or not to emit light) for each subframe SF, and the emission time of the pixel is controlled by differently setting the emission period of each subframe SF, and by providing a weight (e.g., a length) to the set emission period. Accordingly, it is possible for the pixel to express a desired gray scale level. When the organic light emitting display device is driven by the digital driving method, it is possible to improve the accuracy of gray scale level expression.

However, when the organic light emitting display device is driven by the digital driving method, one frame 1F is divided into a plurality of subframes SF, and a corresponding data signal is written while sequentially selecting the scan lines S during each subframe SF. In other words, when the digital driving method is used, gray scale levels are expressed while repeatedly charging/discharging the data lines D and the capacitor C in each pixel with a fast frequency. Accordingly, as charging/discharging power consumption increases, the entire power consumption increases.

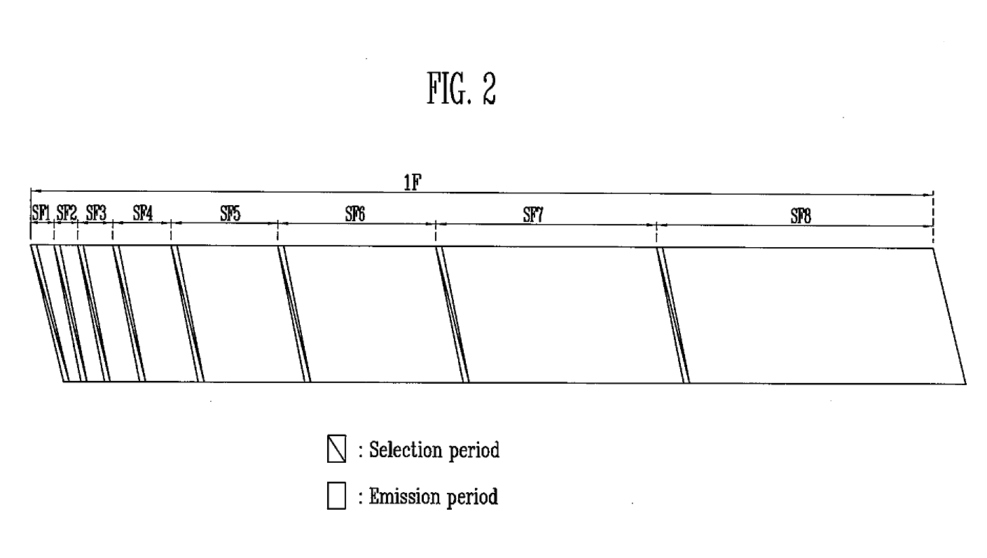

As display panels become large in size and high in resolution, the number of lines to be driven increases, and the driving frequency also increases. Thus, the increase in power consumption may be serious or significant. Accordingly, aspects of example embodiments of the present invention relate to a method for reducing the entire power consumption by reducing the charging/discharging power consumption, even when the organic light emitting display device is driven by the digital driving method. Hereinafter, an organic light emitting display device and a driving method thereof according to example embodiments of the present invention will be described in detail with reference to FIGS. 3 to 9.

FIG. 3 is a block diagram illustrating an organic light emitting display device according to an example embodiment of the present invention.

Referring to FIG. 3, an organic light emitting display device according to an example embodiment includes a plurality of pixels 200 located at a display area 100, scan and data drivers 300 and 400 configured to drive the pixels 200, a timing controller 500 configured to drive the scan and data drivers 300 and 400, and a data voltage generator 700 configured to supply data voltages VGH and VGL to the data driver 400.

The organic light emitting display device according to the example embodiment illustrated in FIG. 3 further includes a data voltage controller 600 configured to generate a voltage control signal VCS using input image data Data, and to output the generated voltage control signal VCS to the data voltage generator 700. The data voltage controller 600, for example, may be a part of the timing controller 500. However, the present invention is not limited thereto, and the data voltage controller 600 may be provided at an outside of the timing controller 500.

Scan lines S1 to Sn and data lines D1 to Dm, which are arranged in directions crossing each other, and the plurality of pixels 200 respectively located at crossing regions of the scan lines S1 to Sn and the data lines D1 to Dm, may be provided at the display area 100.

Each pixel 200 includes an organic light emitting diode configured to emit light with a luminance corresponding to a data signal supplied from the data lines D1 to Dm, and may further include a pixel circuit configured to control the organic light emitting diode, and the like. For example, each pixel 200 may be configured as shown in FIG. 1 described above, but the present invention is not limited thereto.

When the organic light emitting display device is driven by the digital driving method, each of the pixels 200 receive a data signal set to first or second data, and the pixels 200 selectively emit light (e.g., emit light or do not emit light) corresponding to (e.g., according to) the data signal. The first and second data may be set to a voltage level corresponding to the first or second voltage VGH or VGL output from the data voltage generator 700.

The first and second data may be set to have voltage levels opposite to each other. For example, when the first data is set as data for allowing the pixels not to emit light, e.g., data of ‘0’, and to have the first voltage VGH of a high voltage, the second data may be set as data for allowing the pixels to emit light, e.g., data of ‘1’, and to have the second voltage VGL of a low voltage. However, the present invention is not limited thereto, and the voltage levels of the first and second data may be changed, for example, depending on the type of a driving transistor (e.g., second transistor M2) included in the pixel circuit.

The pixels 200 receive a first pixel power source ELVDD, a second pixel power source ELVSS, scan signals, and data signals, supplied from the outside. The pixels 200 display an image corresponding to the data signals.

For example, when the organic light emitting display device is driven by the digital driving method, each pixel 200 receives a data signal set to the first or second data from a data line D (e.g., D1-Dm), when a scan signal is supplied to a scan line S (e.g., S1-Sn) coupled thereto, during subframes SF (e.g., SF1-SF8) having different weights (e.g., lengths). The pixels 200 emit light or do not emit light, corresponding to the data signal during an emission period of the corresponding subframe SF, thereby displaying gray scale levels.

The scan driver 300 generates a scan signal corresponding to a scan control signal SCS supplied from the timing controller 500, and supplies the generated scan signal to the scan lines S1 to Sn. When the scan signal is supplied to the scan lines S1 to Sn, the pixels 200 are selected for each horizontal line.

For example, when the organic light emitting display device is driven by the digital driving method, the scan driver 300 supplies the scan signals to the scan lines S1 to Sn during the selection period of each subframe SF (e.g., SF1-SF8).

The data driver 400 generates data signals, using a data control signal DCS and input image data, which are supplied from the timing controller 500, and the first and second voltages VGH and VGL supplied from the data voltage generator 700. The data driver 400 outputs the generated data signals to the pixels 200 through the data lines D1 to Dm.

For example, when the organic light emitting display device is driven by the digital driving method, the data driver 400 supplies the data signals set to the first or second data to the data lines D1 to Dm, whenever the scan signals are supplied to the scan lines S1 to Sn during the selection period of each subframe SF. Then, the pixels 200 receiving the first data supplied during an emission period included in a subframe SF do not emit light during the emission period of the corresponding subframe SF (e.g., SF1-SF8), and the pixels receiving the second data emit light during the emission period of the corresponding subframe SF.

The timing controller 500 generates a scan control signal SCS and a data control signal DCS corresponding to control signals, such as a vertical/horizontal synchronization signal, a clock signal, and an enable signal, which are supplied from the outside. The scan control signal SCS and the data control signal DCS generated in the timing controller 500, are respectively supplied to the scan driver 300 and the data driver 400 to control operations of the scan and data drivers 300 and 400. The timing controller 500 receives input image data Data supplied from the outside, realigns the input image data Data, and transmits the realigned input image data Data to the data driver 400. Then, the data driver 400 generates a data signal corresponding to the input data Data.

The timing controller 500, for example, may be a part of the data voltage controller 600, but the present invention is not limited thereto.

The data voltage controller 600 receives input image data Data supplied from the outside, and calculates power consumption (e.g., predetermined power consumption) using the input image data Data. Subsequently, the data voltage controller 600 generates a voltage control signal VCS corresponding to the power consumption, and outputs the generated voltage control signal VCS to the data voltage generator 700.

For example, the data voltage controller 600 may calculate charging/discharging power consumption corresponding to the input image data Data, and may output the voltage control signal VCS. The voltage control signal VCS may be used for controlling a voltage difference between the first and second voltages VGH and VGS, to be regulated corresponding to the calculated charging/discharging power consumption. The data voltage controller 600 may be designed to calculate charging/discharging power consumption with respect to a total power consumption, and to generate the voltage control signal VCS corresponding to the calculated charging/discharging power consumption.

For example, the data voltage controller 600 generates the voltage control signal VCS corresponding to the expected (e.g., calculated) charging/discharging power consumption. The expected charging/discharging power consumption may be reduced by controlling the voltages of the first and second voltages VGH and VGS, so that a difference between the first and second voltages VGH and VGS is decreased as the expected charging/discharging power consumption increases.

However, if the voltage difference between the first and second voltages VGH and VGS is decreased to lower than a limit value (e.g., a predetermined limit value), a deterioration of image quality caused by the luminance lowering of the pixels 200, may occur. Therefore, the data voltage controller 600 may generate the voltage control signal VCS so that the voltage difference between the first and second voltages VGH and VGS may not be decreased to lower than the limit value, by allowing the voltage difference between the first and second voltages VGH and VGS to be constantly maintained at or near the limit value with respect to the charging/discharging power consumption having a predetermined value or more.

That is, the data voltage controller 600 outputs the voltage control signal VGS for controlling the voltage difference between the first and second voltages VGH and VGS to be decreased as the charging/discharging power consumption increases. The data voltage controller 600 outputs the voltage control signal VGS so that the voltage difference between the first and second voltages VGH and VGS are constantly maintained with respect to the charging/discharging power consumption having the predetermined value or more.

For example, in an example embodiment, the data voltage controller 600 may calculate a transition counting value corresponding to the input image data Data set to a digital value, and may generate the voltage control signal VCS based on the calculated transition counting value. In another example embodiment, the data voltage controller 600 may calculate an image loading value corresponding to the input image data Data set to an analog or digital value, and may generate the voltage control signal based on the calculated image loading value. However, the present invention is not limited thereto, and the data voltage controller 600 may generate the voltage control signal VCS by applying various calculations to determine a predetermined power consumption using the input image data Data. Example embodiments related to the data voltage controller 600 will be described in detail later.

The data voltage generator 700 generates the first and second voltages VGH and VGL used to generate a data signal, by using an input power source from the outside thereof, and outputs the generated first and second voltages VGH and VGL to the data driver 400. In example embodiments, the data voltage generator 700 may be configured integrally with a power supply unit for generating the first and second pixel power sources ELVDD and ELVSS, or may be configured separately from the power supply unit. However, the present invention is not limited thereto.

The data voltage generator 700 according to an example embodiment regulates and outputs at least one of the first and second voltages VGH and VGL, corresponding to the voltage control signal VCS supplied from the data voltage controller 600.

For example, the data voltage generator 700 may include a variable circuit for varying and outputting at least one of the first and second voltages VGH and VGL. That is, the data voltage generator 700 may include a first variable circuit for varying and outputting the first voltage VGH, and/or a second variable circuit for varying and outputting the second voltage VGL.

When at least one of the first and second voltages VGH and VGL is regulated, the voltage difference between the first and second voltages VGH and VGL, e.g., the voltage range of the data signal, is regulated.

For example, when the first voltage VGH is decreased in a state in which the second voltage VGL is fixed, when the second voltage VGL is increased in a state in which the first voltage VGH is fixed, or when the first voltage VGH is decreased and the second voltage VGL is increased, the voltage range of the data signal is decreased.

When the voltage range of the data signal is decreased as described above, the charging/discharging power consumption consumed when charging/discharging data lines D1 to Dm and/or capacitors in the pixels 200 is decreased, thereby reducing the entire power consumption.

A driving method of the organic light emitting display device according to an example embodiment includes: calculating a predetermined power consumption (e.g., charging/discharging power consumption) corresponding to input image data Data; generating a voltage control signal VCS corresponding to the power consumption; regulating and outputting a first voltage VGH and/or a second voltage VGL used to generate a data signal corresponding to the voltage control signal VCS; generating a data signal set to a first data corresponding to the first voltage VGH or a second data corresponding to the second voltage VGL using the input image data Data, the first voltage VGH, and the second voltage VGL; and allowing the pixels 200 to selectively emit light (e.g., to emit light or not to emit light) according to the data signal supplied to the data lines D1 to Dm.

For example, according to the described embodiment, the voltage range of the data signal is controlled to decrease as the power consumption calculated based on the input data Data increases. Accordingly, it is possible to reduce the charging/discharging power consumption generated from writing of the data signal, while allowing the organic light emitting display device to be driven by the digital driving method.

In an example embodiment, the voltage range of the data signal is constantly maintained with respect to the power consumption having a predetermined value, so that it is possible to prevent or reduce the deterioration of image quality caused by the luminance lowering of the pixels 200.

When the power consumption calculated based on the input image data Data is small, the voltage range of the data signal is set to be relatively large. Thus, the contrast ratio is secured, thereby enhancing the expression ability of a black gray scale level.

That is, in the organic light emitting display device and the driving method thereof according to the described embodiment, the voltage range of the data signal is optimized by varying the first voltage VGH and/or the second voltage VGL based on the input data Data, so that it may be possible to reduce the charging/discharging power consumption and to prevent or reduce the deterioration of image quality.

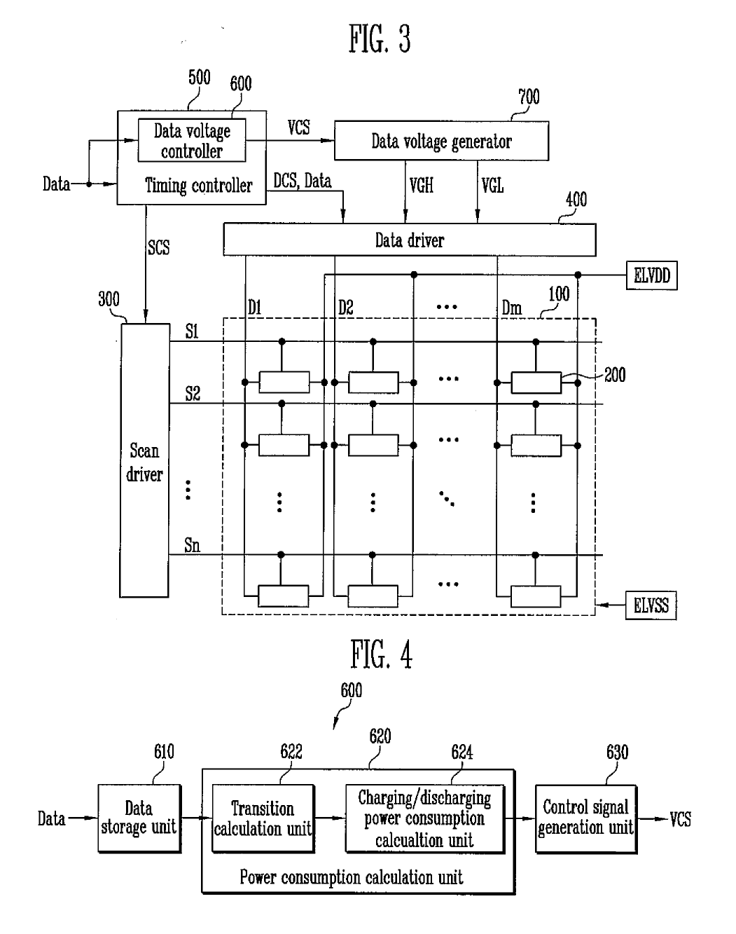

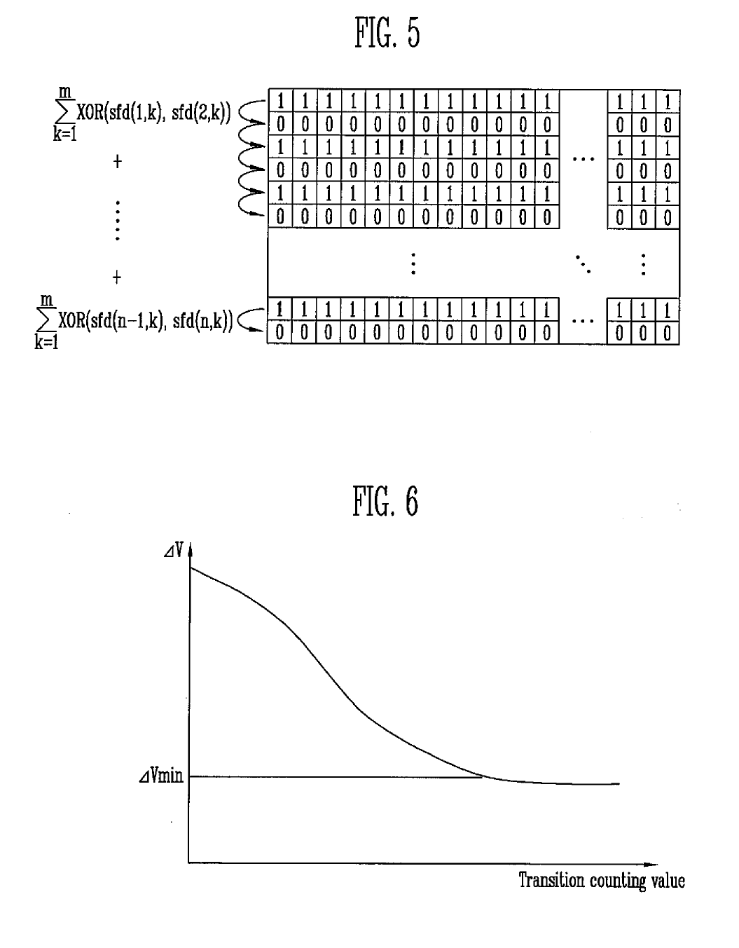

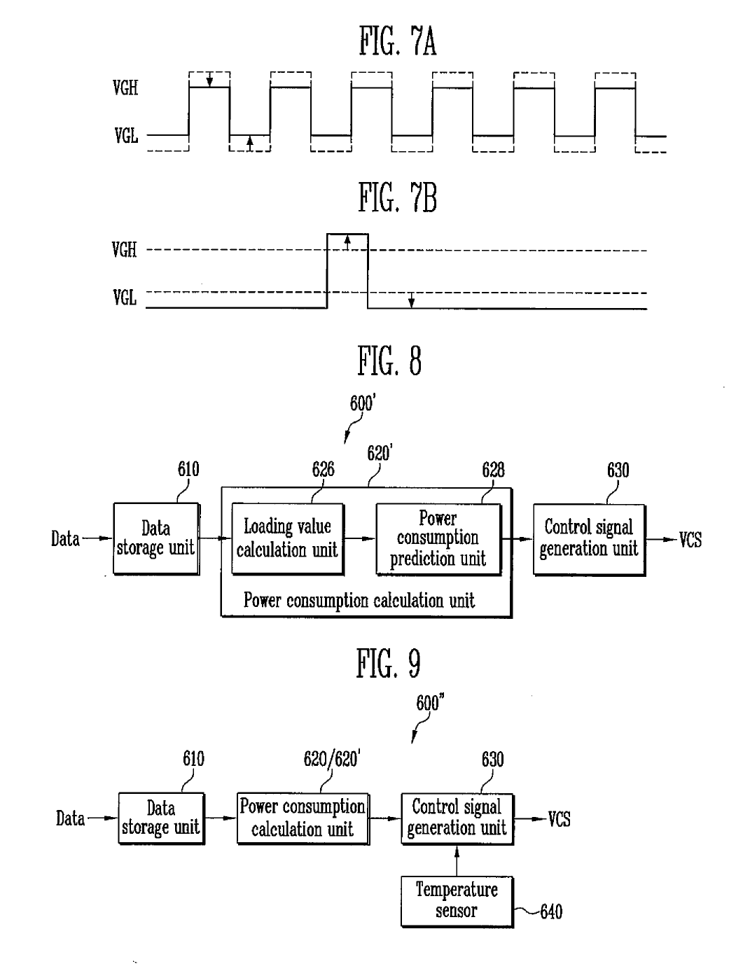

FIG. 4 is a block diagram illustrating a data voltage controller according to an example embodiment of the present invention. FIG. 5 is a diagram illustrating a method of calculating a transition counting value during one subframe period through a transition calculation unit shown in FIG. 4, according to an example embodiment of the present invention. FIG. 6 is a graph illustrating a voltage range of a data signal controlled corresponding to a transition counting value, according to an example embodiment of the present invention. FIGS. 7A and 7B are waveform diagrams illustrating a method of controlling a voltage range of a data signal, corresponding to a transition counting value, according to an example embodiment of the present invention.

First referring to FIG. 4, the data voltage controller 600 according to an example embodiment includes a data storage unit 610, a power consumption calculation unit 620, and a control signal generation unit 630.

The data storage unit 610 stores input image data Data input from an outside thereof during a period (e.g., a predetermined period). For example, the data storage unit 610 may be configured to store the input image data Data to an extent necessary to calculate a transition counting value for each frame or subframe in the power consumption calculation unit 620.

The power consumption calculation unit 620 calculates power consumption (e.g., predetermined power consumption), corresponding to the input image data supplied via the data storage unit 610.

For example, when the input image data Data is supplied in the form of a digital value, the power consumption calculation unit 620 may calculate the number of times the data lines are charged/discharged for each frame based on the input image data Data, and may calculate the charging/discharging power consumption based on the calculated number of times.

Thus, the power consumption calculation unit 620 may include a transition calculation unit 622 and a charging/discharging power consumption calculation unit 624.

The transition calculation unit 622 calculates the number of times the data lines are charged/discharged based on the input image data Data, and outputs the calculated number of times as a transition counting value.

As shown in FIG. 5, the transition calculation unit 622 may add up the number of times the data lines are charged/discharged for each bit of the input image data supplied as a digital value of “0” or “1”, thereby calculating a transition counting value during each subframe.

For example, when horizontal lines of pixels are sequentially selected during the respective subframes, each data line is charged/discharged corresponding to a bit value corresponding to a corresponding subframe, or maintains a previous voltage value.

That is, each data line is charged/discharged when bit values of data signals corresponding to two consecutive horizontal lines are different from each other, and each data line maintains the previous voltage value when the bit values of the data signals corresponding to the two consecutive horizontal lines are equal to each other.

Thus, the transition counting value may be calculated through an exclusive-or (XOR). For example, the transition counting value during each subframe may be calculated by the following Equation 1.

$$TCsf = {\sum }_{i = 1}^{n - 1} {\sum }_{k = 1}^{m} XOR ( sfd ( i , k ) , sfd ( i + 1 , k ) ) \qquad Equation 1$$

Here, TCsf denotes a transition counting value during a corresponding subframe, and sfd(i, k) denotes a bit value of a data signal corresponding to the corresponding subframe, for example, a bit value of a data signal supplied to a pixel positioned on an i-th (i is a natural number) horizontal line and a k-th (k is a natural number) vertical line. In addition, n and m (n and m are natural numbers) respectively denote the number of horizontal lines and the number of vertical lines.

Therefore, the transition counting value during one frame may be set as a value obtained by adding up transition counting values during each subframe included in the corresponding one frame.

Thus, the transition calculation unit 622 can calculate the number of times when the data lines are charged/discharged for each frame, and output the calculated number of times as a transition counting value TC.

Referring back to FIG. 4, the charging/discharging power consumption calculation unit 624 calculates charging/discharging power consumption based on the transition counting value output from the transition calculation unit 622, and outputs the calculated charging/discharging power consumption to the control signal generation unit 630.

The charging/discharging power consumption is in proportion to the square value of the voltage range of the data signal (e.g., (VGH−VGL)²), the capacitance existing in the data lines, the number of subframes, and the like. Therefore, the charging/discharging power consumption calculation unit 624 may calculate and output charging/discharging power consumption consumed in the charging/discharging of the data lines, using a function (e.g., a predetermined function) corresponding to the charging/discharging power consumption.

That is, in an example embodiment, the calculating of the charging/discharging power consumption by the power consumption calculation unit 620 may include calculating the number of times the data lines are charged/discharged based on the input image data Data supplied in the form of a digital value, outputting the calculated number of times as a transition counting value, and calculating the charging/discharging power consumption based on the transition counting value.

However, the operation of the power consumption calculation unit 620 according to example embodiments of the present invention are not limited thereto. For example, the power consumption calculation unit 620 may calculate an image loading value based on the input image data Data, and may calculate and output power consumption corresponding to the calculated image loading value.

The control signal generation unit 630 generates and outputs a voltage control signal VCS corresponding to the power consumption calculated by the power consumption calculation unit 620.

For example, when the power consumption calculation unit 620 calculates charging/discharging power consumption based on the transition counting value, and supplies the calculated charging/discharging power consumption to the control signal generation unit 630, the control signal generation unit 630 may generate the voltage control signal VCS for controlling the voltage range of the data signal to be decreased as the charging/discharging power consumption increases. However, in order to prevent or reduce the decrease in luminance of the pixels, the control signal generation unit 630 may generate the voltage control signal VCS for controlling the voltage range of a data signal (e.g., a predetermined data signal) to be maintained with respect to the charging/discharging power consumption having a predetermined value or more.

That is, in the described embodiment, the voltage range of the data signal is regulated corresponding to the transition counting value. For example, the voltage range of the data signal may be set as shown in FIG. 6.

Referring to FIG. 6, the charging/discharging power consumption for writing a data signal is reduced by setting the voltage range ΔV of the data signal as the transition counting value increases. For example, the transition counting value having a predetermined value or more is set so that the voltage range ΔV of the data signal maintains a minimum value ΔVmin (e.g., a predetermined minimum value), thereby preventing or reducing the deterioration of image quality, caused by a decrease in luminance.

For convenience of illustration, an example of regulating the voltage range ΔV of the data signal along a continuous curve has been illustrated in FIG. 6. However, the present invention is not limited thereto, and the method of regulating the voltage range ΔV of the data signal may be variously modified and embodied.

For example, the control signal generation unit 630 may divide the power consumption (e.g., the charging/discharging power consumption) calculated in the power consumption calculation unit 620 into a plurality of steps depending on a range of the power consumption, and store, in the form of a lookup table, a voltage range regulation value of the data signal with respect to the power consumption having the corresponding range.

When the power consumption of a corresponding frame is supplied from the power consumption calculation unit 620, the control signal generation unit 630 may extract a voltage range regulation value of the data signal corresponding to the power consumption of the corresponding frame, and may generate the voltage control signal VCS. In this case, the voltage range ΔV of the data signal may be regulated in a step form according to the transition counting value.

The control signal generation unit 630 may be designed to regulate the voltage range ΔV of the data signal (e.g., to lower the voltage range ΔV of the data signal) when the power consumption is beyond a predetermined power consumption reference value.

The voltage control signal VCS generated in the control signal generation unit 630 as described above is supplied to the data voltage generator 700 shown in FIG. 3, to be used in varying the first voltage VGH and/or the second voltage VGL.

For example, as shown in FIG. 7A, when the transition counting value during a corresponding frame is large, the control signal generation unit 630 may control the voltage range ΔV of the data signal to be decreased by controlling the first and second voltages VGH and VGL. The first and/or second voltages VGH and VGL may be controlled so that the first voltage VGH is decreased in a state in which the second voltage VGL is fixed, the second voltage VGL is increased in a state in which the first voltage VGH is fixed, or the first voltage VGH is decreased and the second voltage VGL is increased. When the voltage range ΔV of the data signal is decreased as described above, the charging/discharging power consumption can be reduced.

On the other hand, when the transition counting value during the corresponding frame is small, the voltage range ΔV of the data signal may be maintained at an original setting value where the voltage range ΔV of the data signal has not been decreased, or the voltage range ΔV may be increased as shown in FIG. 7B, thereby enhancing the expression ability of the pixels to display a black gray scale level. For example, the voltage range ΔV of the data signal may be increased by controlling the first and/or second voltages VGH and VGL so that the first voltage VGH is increased in a state in which the second voltage VGL is fixed, the second voltage VGL is decreased in a state in which the first voltage VGH is fixed, or the first voltage VGH is increased and the second voltage VGL is decreased.

FIG. 8 is a block diagram illustrating a data voltage controller according to another example embodiment of the present invention. For convenience, in FIG. 8, portions or elements that are identical or similar to those of the embodiment shown in FIG. 4 are designated by like reference numerals, and their detailed descriptions may be omitted.

Referring to FIG. 8, a power consumption calculation unit 620′ included in the data voltage controller 600′, includes a loading value calculation unit 626 and a power consumption prediction unit 628.

The loading value calculation unit 626 calculates and outputs an image loading value corresponding to the input image data Data supplied via the data storage unit 610. For example, the loading value calculation unit 626 may calculate and output an image loading value for each frame, corresponding to the input image data Data supplied in the form of an analog or digital value. The loading value calculation unit 626 may divide a screen into a plurality of areas, and may separately output an image loading value for each area.

The power consumption prediction unit 628 predicts power consumption corresponding to the image loading value output from the loading value calculation unit 626, and supplies the predicted power consumption to the control signal generation unit 630. When the image loading value is large, the emission power consumption is large. When the image loading value is small, the emission power consumption is small.

That is, in the described embodiment, the calculating of the power consumption in the power consumption calculation unit 620′ includes calculating an image loading value corresponding to the input image data Data, and predicting the power consumption corresponding to the image loading value.

When the power consumption is calculated by the power consumption calculation unit 620′ as described above, the control signal generation unit 630 generates and outputs a voltage control signal VCS corresponding to the calculated power consumption.

For example, the control signal generation unit 630 may generate and output the voltage control signal VCS for controlling the voltage range ΔV of the data signal to be decreased when the calculated power consumption is large (e.g., the image loading value is large), and controlling the voltage range ΔV of the data signal to be increased when the calculated power consumption is small (e.g., the image loading value is small).

However, in an example embodiment, only the power consumption corresponding to the image loading value in a predetermined range is optimized, so that the voltage range ΔV of the data signal is regulated within only the predetermined range. As such, it may be possible to reduce the charging/discharging power consumption for writing a data signal and to prevent or reduce the deterioration of image quality.

FIG. 9 is a block diagram illustrating a data voltage controller according to still another example embodiment of the present invention. For convenience, in FIG. 9, portions or elements identical or similar to those of the embodiments shown in FIGS. 4 and 8 are designated by like reference numerals, and their detailed descriptions may be omitted.

Referring to FIG. 9, the data voltage controller 600″ according to still another example embodiment further includes a temperature sensor 640. However, the present invention is not limited thereto, and in other embodiments, the temperature sensor 640 may not be formed, together with the data storage unit 610, the power consumption calculation unit 620/620′, and/or the control signal generation unit 630, in the data voltage controller 600″. The installation position of the temperature sensor 640 may be variously modified and embodied. That is, although it has been illustrated in FIG. 9 that, for convenience, the temperature sensor 640 is a component included in the data voltage controller 600″, the temperature sensor 640 may be configured as a component separate from the data voltage controller 600″.

The temperature sensor 640, for example, is used to more precisely regulate the voltage range ΔV of the data signal by reflecting a temperature environment in which the pixels are driven. The temperature sensor 640, for example, may be mounted on a panel to be adjacent to the pixels.

The temperature sensor 640 senses a temperature of the panel on which the pixels are disposed, and outputs, to the control signal generation unit 630, a temperature signal corresponding to the sensed temperature.

The control signal generation unit 630 may generate a voltage control signal VCS by reflecting the temperature signal, in addition to the power consumption calculated by the power consumption calculation unit 620/620′.

That is, the driving method of the organic light emitting display device including the data voltage controller 600″ according to an example embodiment further includes sensing a temperature of the panel on which the pixels are disposed, and outputting a temperature signal corresponding to the sensed temperature, in addition to the calculating of the power consumption corresponding to the input image data Data, and generating the voltage control signal VCS reflecting both the power consumption and the temperature signal.

For example, when the temperature of the panel is increased to a reference value or more (e.g., predetermined reference value or more), the voltage range ΔV of the data signal may be regulated to be additionally decreased by an offset value (e.g., a predetermined offset value). When the temperature of the panel is decreased to the reference value or less, the voltage range ΔV of the data signal may be regulated to be maintained or to be additionally increased by the offset value.

When the temperature of the panel is increased, a higher current flows with respect to the data signal having the same voltage, as the driving voltage of the organic light emitting diode is decreased. When the temperature of the panel is decreased, a lower current flows with respect to the data signal having the same voltage, as the driving voltage of the organic light emitting diode is increased. Thus, the voltage range ΔV of the data signal is regulated to be optimized according to the driving temperature of the panel.

According to the described embodiment, the voltage range ΔV of the data signal can be further optimized by reflecting the temperature of the panel sensed by the temperature sensor 640, in addition to the predetermined power consumption calculated based on the input image data Data.

As described above, according to the described embodiments of the present invention, power consumption is calculated using an input image data, and the voltage range of a data signal is regulated corresponding to the calculated power consumption. Accordingly, it may be possible to reduce charging/discharging power consumption generated during the writing of the data signal, while driving the organic light emitting display device according to the digital driving method.

Further, according to example embodiments of the present invention, the voltage range of the data signal can be regulated so that the charging/discharging power consumption becomes a predetermined limit value or less. Thus, it is possible to control the maximum value of the charging/discharging power consumption to be constantly maintained.

Although example embodiments in which aspects of the present invention is applied to an organic light emitting display device using the digital driving method have been described, the present invention is not necessarily limited thereto. That is, the voltage range of the data signal is optimized based on the input image data Data, so that the spirit and scope of the present invention of preventing or reducing the deterioration of image quality while reducing the charging/discharging power consumption may be variously modified and embodied. For example, the present invention may be applied to other displays such as a plasma display panel (PDP).

By way of summation and review, when an organic light emitting display device is driven by the digital driving method, gray scale levels are expressed while repeatedly charging/discharging data lines and capacitors in pixels with a fast frequency. Hence, the charging/discharging power consumption may be large.

For example, as display panels become large in size and high in resolution, the number and length of data lines to be driven increase, and the driving frequency also increases. Hence, the increase in power consumption may become serious or significant. Accordingly, aspects of example embodiments of the present invention relate to reducing the charging/discharging power consumption, while driving the organic light emitting display device according to the digital driving method.

According to example embodiments of the present invention, power consumption is calculated using input image data, and the voltage range of a data signal is regulated corresponding to the calculated power consumption. Accordingly, it may be possible to reduce charging/discharging power consumption generated during the writing of the data signal, while driving the organic light emitting display device according to the digital driving method.

Example embodiments have been described herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments, unless otherwise specifically indicated. Accordingly, it will be understood by those of skill in the art that various changes in form and details may be made without departing from the spirit and scope of the present invention as set forth in the following claims, and their equivalents.

What is claimed is:

1. An organic light emitting display device comprising:
a data voltage controller configured to calculate power consumption according to input image data, and to output a voltage control signal corresponding to the calculated power consumption;
a data voltage generator configured to regulate and output at least one of first and second voltages corresponding to the voltage control signal;
a data driver configured to generate a data signal according to the input image data and at least one of the first voltage or the second voltage, and to output the data signal; and
a plurality of pixels configured to selectively emit light corresponding to the data signal.

2. The organic light emitting display device of claim 1, wherein the data voltage controller is further configured to calculate charging/discharging power consumption corresponding to the input image data, and to output the voltage control signal for controlling a voltage difference between the first and second voltages to be regulated corresponding to the charging/discharging power consumption.

3. The organic light emitting display device of claim 2, wherein the data voltage controller is further configured to output the voltage control signal for decreasing the voltage difference between the first and second voltages as the charging/discharging power consumption increases.

4. The organic light emitting display device of claim 3, wherein the data voltage controller is further configured to output the voltage control signal for constantly maintaining the voltage difference between the first and second voltages when the charging/discharging power consumption has at least a predetermined value.

5. The organic light emitting display device of claim 1, wherein the data voltage controller comprises:
a data storage unit configured to store the input image data during a period;
a power consumption calculation unit configured to calculate the power consumption corresponding to the input image data; and
a control signal generation unit configured to generate and output the voltage control signal corresponding to the power consumption.

6. The organic light emitting display device of claim 5, wherein the input image data has a digital value.

7. The organic light emitting display device of claim 5, wherein the power consumption calculation unit comprises:
a transition calculation unit configured to calculate a number of times data lines are charged/discharged based on the input image data, and to output the calculated number of times as a transition counting value; and
a charging/discharging power consumption calculation unit configured to calculate charging/discharging power consumption based on the transition counting value.

8. The organic light emitting display device of claim 7, wherein the transition calculation unit is further configured to calculate the transition counting value for each frame.

9. The organic light emitting display device of claim 5, wherein the power consumption calculation unit comprises:
a loading value calculation unit configured to calculate an image loading value corresponding to the input image data; and
a power consumption prediction unit configured to predict power consumption corresponding to the image loading value.

10. The organic light emitting display device of claim 5, wherein the data voltage generator is further configured to generate the first and second voltages, and to output the generated first and second voltages to the data driver, and
wherein the data voltage generator comprises a variable circuit configured to vary and output at least one of the first and second voltages corresponding to the voltage control signal.

11. The organic light emitting display device of claim 5, further comprising a temperature sensor configured to sense a temperature of a panel on which the pixels are located, and to output a temperature signal corresponding to the sensed temperature.

12. The organic light emitting display device of claim 11, wherein the control signal generation unit is further configured to generate the voltage control signal according to both the power consumption and the temperature signal.

13. A method of driving an organic light emitting display device, the method comprising:
calculating power consumption corresponding to input image data;
generating a voltage control signal corresponding to the power consumption;
regulating and outputting at least one of first and second voltages corresponding to the voltage control signal;
generating a data signal according to the input image data and at least one of the first voltage or the second voltage; and
supplying the data signal to pixels to selectively emit light corresponding to the data signal.

14. The method of claim 13, wherein the calculating of the power consumption comprises calculating charging/discharging power consumption corresponding to the input image data.

15. The method of claim 14, wherein the calculating of the charging/discharging power consumption comprises:
calculating a number of times data lines are charged/discharged based on the input image data supplied in a form of a digital value, and outputting the calculated number of times as a transition counting value; and
calculating the charging/discharging power consumption based on the transition counting value.

16. The method of claim 13, wherein the generating of the voltage control signal comprises generating the voltage control signal for controlling a voltage difference between the first and second voltages so that the voltage difference is decreased as the power consumption increases.

17. The method of claim 16, wherein the generating of the voltage control signal comprises generating the voltage control signal for constantly maintaining the voltage difference between the first and second voltages when the power consumption has at least a predetermined value.

18. The method of claim 13, wherein the calculating of the power consumption comprises:
calculating an image loading value corresponding to the input image data; and
predicting power consumption corresponding to the image loading value.

19. The method of claim 13, further comprising sensing a temperature of a panel on which the pixels are located, and outputting a temperature signal corresponding to the sensed temperature.

20. The method of claim 19, wherein the voltage control signal is generated according to both the power consumption and the temperature signal.
